(19) United States
(12) Patent Application Publication
(10) Pub. No.: US 2008/0119995 A1
(43) Pub. Date: May 22, 2008

(54) Control Apparatus And Method For Controlling An Adjusting Device In A Motor Vehicle

(76) Inventors: Wolfgang Ubel, Weitramsdorf (DE); Markus Schussler, Zeitlofs (DE); Jurgen Buhlheller, Hainert (DE)

Correspondence Address: WHITE & CASE LLP;PATENT DEPARTMENT, 1155 AVENUE OF THE AMERICAS, NEW YORK, NY, 10036, US

(21) Appl. No.: 11/571,146

(22) PCT Filed: Jun. 24, 2005
(86) PCT No.: PCT/EP05/06850

§ 371 Date: Sep. 26, 2007

(30) Foreign Application Priority Data
Jun. 24, 2004 (DE) 20 2004 009 922.5

(51) Int. Cl. H02H 7/085

(52) U.S. Cl. 701/49

(57) ABSTRACT

A control apparatus for an adjusting device in a motor vehicle has a sensor for generating a signal which is dependent on a drive movement of a drive in the adjusting device and has a processor which is set up for an evaluation function for a parameter in the time scale range of the transformed signal for the purpose of controlling the drive. This function is used to control an adjusting device in a motor vehicle, particularly a motor vehicle seat adjuster, a window lifter or a door opener. In this case, a signal generated on the basis of a drive movement of a drive in the adjusting device needs to be transformed. The processor preferably has a control function in order to control the drive on the basis of a parameter in the time scale range of the transformed signal.

The invention relates to a control apparatus and a method for controlling an adjusting device in a motor vehicle.

The invention is based on the object of specifying a particularly suitable method for controlling an adjusting device in a motor vehicle. In addition, the aim is to specify a control apparatus which allows an improvement in the control of an adjusting device in a motor vehicle.

For the method, the invention achieves the stated object by means of the features of Claim 1. Advantageous developments are covered by the subclaims which refer back to this claim. For the apparatus, the invention achieves the stated object by means of the features of Claim 44. Expedient refinements are covered by the subclaims which refer back to this claim.

Accordingly, a control apparatus for an adjusting device in a motor vehicle has a sensor for generating a signal which is dependent on a drive movement of a drive in the adjusting device and has a processor which is set up for an evaluation function for a parameter in the time scale range of the transformed signal for the purpose of controlling the drive. This function is used to control the adjusting device, particularly to control a motor vehicle seat adjuster, to control a window lifter or to control a door opener. In this case, a signal generated on the basis of a drive movement of a drive in the adjusting device needs to be transformed. The processor preferably has a control function in order to control the drive on the basis of a parameter in the time scale range of the transformed signal.

Preferably, the signal is generated on the basis of a torque for the drive movement of the drive. In this regard, use may be made of the fact that the torque correlates to a motor parameter. By way of example, the torque correlates to the instantaneous speed or to the instantaneous motor current of the drive. The correlation is a proportionality between torque and motor current, for example.

Expediently, a window function is used for the transformation. The window function is preferably adaptable by adapting particularly the boundaries of the window. In this case, the adaptation is made preferably on the basis of ascertained parameters of the adjusting device, particularly on the basis of ascertained restrictions within the adjusting path. Another option is to adapt the number of window functions and particularly to add further window functions.

In one particularly preferred development of the invention, the generated signal is transformed using a wavelet transformation. The wavelet transformation is performed using a basis wavelet. The term wavelet transformation is used to describe an entire class of transformations. Examples of important classes are Riesz, dyadic, simple, biorthogonal, semiorthogonal and orthogonal wavelets. To evaluate the generated signals using a wavelet transformation, a discrete version of wavelet decomposition is preferably used. The wavelet transformation transforms the generated signal into the time scale range. In this context, a scale corresponds to a frequency component of the signal which is to be transformed. By way of example, the scale is the inverse of one of these frequencies.

The generated signal has a plurality of different constituents. In addition to the useful signal associated with the motor movement, the generated signal contains further signal components, such as noise signals or DC components with possible drift. Preferably, the scales are designed such that the different signal components are resolved on different scales. To this end, a scale is designed for the drive's rated revolution frequency which is to be expected. In addition, a scale may be designed for the ripple in the drive current for a mechanically commutated electric motor as drive. In combination or alternatively, it is advantageous to evaluate the lower-frequency components of the change in the absolute value of the motor current as a useful signal on one or more scales.

In addition, it may also be advantageous to split the or each useful signal deliberately in a respective proportion over a plurality of scales in order to allow different operating states or operating events through the individual or combined evaluation of a plurality of scales. The transformed signal's parameter to be evaluated is preferably a measure of a component of one or more scales in the generated signal. By way of example, two scales can be related to one another by an algorithm by virtue of the values on one scale varying a threshold value for evaluating another scale. Advantageously, the parameter in this case is a measure of the component in the generated signal in relation to a time unit. The time unit is different for each scale. In this context, scales which are associated with a higher-frequency signal component in the generated signal are governed by a smaller time unit than comparatively low-frequency signal components.

In line with one advantageous development, dependent control is achieved by evaluating the parameters for one or more scales. The combined evaluation is used to identify different operating states and to evaluate them for control.

To this end, the control apparatus stores an algorithm or a parameter set for evaluating the response of the drive motor, particularly for the startup behavior, the rated operation, the braking response and forces acting externally on the adjusting device and hence on the motor, as in the case of blocking or restriction.

In line with one advantageous embodiment, different spring rates for the mechanical system of the adjusting device, particularly on different scales, are evaluated. In this case, different spring rates may be inherent to the mechanical system of the adjusting device, for example by virtue of blocking on a hard mechanical stop being detected within a scale. Other spring rates may be caused by external influences, for example as a result of objects or body parts trapped by the adjusting device. Typical spring rates for soft and hard trapped body parts are 65 N/mm and 10 N/mm.

If a gear in the mechanical system has recurring characteristics within the adjusting path, these can be evaluated as one or more inherent frequencies of a gear or of a plurality of gears in this mechanical system, preferably on a respective scale. To this end, the gears may also be designed specifically to allow such evaluation.

In another development, one or more scales are back-transformed in order to subtract noise signals, particularly those ascertained for fresh transformation, from the generated signal. The useful signal with the noise signals removed can then either be transformed again or can be used alternatively or in combination directly for controlling the drive, particularly for controlling the speed of the drive, for example using phase coupling.

Preferably, control is achieved by stopping the drive. Subsequently, the drive direction is reversed if the adjusting device detects that an object or body part is trapped. To this end, a characteristic of the parameter for the instance of trapping is identified. By way of example, the characteristic is the rise or fall in the parameter above or below one or more threshold values.

Preferably, the characteristic of the parameter is a characteristic of the time profile of the parameter of the transformed signal. A characteristic of the time profile of the parameter is, in particular, a parameter value which occurs at a particular time and which is not expected by the control apparatus at this adjusting location or at this adjusting time. Advantageously, in this regard the characteristic of the time profile is, in combination or alternatively, a value for a change in the parameter over time. The change in the parameter over time is one or more integrations, for example, or the first, second or one or more further derivations based on time and/or based on location which can each be evaluated individually or else in combination, for example using algorithms or threshold values. Accordingly, one advantageous embodiment involves the characteristic being an excess above and/or a shortfall below one or more threshold values by the parameter and/or a change in the parameter over time.

Another advantageous possibility is that the characteristic is a value for a transform of the parameter. In this case, in addition to the wavelet transformation, it is also possible to use another transformation which allows simple evaluation or whose output values can be used directly for control. In line with one embodiment, the evaluation of the characteristic using this transformation is also advantageously combined with the aforementioned evaluation using a threshold value or a simple algorithm.

In line with one advantageous development, at least one of the threshold values provided for evaluation is adapted. By way of example, adaptation is achieved by overwriting the register value for the threshold value. Preferably, the at least one threshold value is adapted on the basis of the drive movement and/or on the basis of a mode of operation of the adjusting device and/or on the basis of one or more further parameters of the motor vehicle. The adaptation can be effected on the basis of known or ascertained mechanical parameters of the mechanical system or on the basis of external conditions of the drive. By way of example, the adaptation is effected on the basis of a particular spring rate when the adjusting movement is blocked. It is also advantageous to adapt the threshold value on the basis of ascertained restrictions in the mechanics of the adjusting device.

In another advantageous development, the at least one threshold value is adapted on the basis of a particular surface integral for the values of the parameter. This surface integral is preferably formed within a scale. Alternatively, integration over the surface of a plurality of scales is also advantageous. The evaluation using the surface integral is particularly advantageously combined with the evaluation of the parameter by virtue of an instance of a body part being trapped occurring through the combined, in particular ANDed, evaluation of the surface integral and of the parameter.

In addition to the illustrated options for adapting the threshold value, the adaptation is effected in line with other embodiments particularly on the basis of one or more spring rates for the mechanical system of the adjusting device, a measured force due to weight acting on the mechanical system of the adjusting device, a measured temperature of the mechanical system and/or of the drive in the adjusting device, a measured or determined (pulse-width modulation) supply voltage for the drive, a present position of the part of the adjusting device which is to be adjusted, or a combination of the aforementioned variables.

For the wavelet transformation, a mother wavelet is used, which is also called a basis wavelet. Another parameter of the wavelet transformation is the scaling function, which is also called the father wavelet. Advantageously, the mother wavelet is adapted to operating states or operating events. One advantageous development therefore provides for the mother wavelet of the wavelet transformation to be designed or adapted on the basis of the signal and/or on the basis of a profile for the signal when the adjusting movement is blocked. In this case, the signal is preferably the generated signal. However, it may alternatively or in combination also be the transformed signal.

In line with another development, when the adjusting movement is blocked at least two different mother wavelets of the wavelet transformation are used for at least two transformations into the time scale range. Preferably, the transformation is effected using at least to some extent the same input data, which, in particular, may be both signals generated by a sensor and previously transformed signals. Preferably, the instance of blocking involves changing over between the at least two mother wavelets.

In line with a first advantageous refinement of this development, the mother wavelet is adapted as seal wavelet to suit the profile of the generated signal for adjusting the part which is to be adjusted into a seal. If the adjustment is stopped by means of a first mother wavelet, for example on account of a detected movement, then the second seal wavelet is used to check whether the blocking can be attributed to the entry into a seal. On the basis of this check, the adjusting movement is subsequently reversed by operating the adjusting device for an adjusting movement in the opposite direction. However, the reversal does not take place if the check identifies the entry into the seal.

In a second advantageous embodiment of this development, the mother wavelet is adapted as block wavelet to suit the profile of the generated signal for adjusting the part which is to be adjusted onto a mechanical stop. Such mechanical stops, for example the lower mechanical stop for a window lifter, have low elasticity. The characteristic profile of the transformed signal allows precise identification of the position on this mechanical stop using a specific block wavelet.

A third, particularly advantageous embodiment of this development provides for the mother wavelet to be adapted as standard wavelet to suit the profile of the generated signal for the instance in which one or more body parts are trapped. This is used particularly for instances of trapping in which a particularly hard object with a low spring rate is trapped and only short reaction times are available for the controlling of electronics.

Different functions of the adjusting device require ascertainment of the present position of the part of the adjusting device which is to be adjusted. A function of this kind is the memory function, for example, in which pushing a button is used to move a vehicle seat into the stored position, for example. In this regard, provision is advantageously made that, in the case of blocking, the present position of the part of the adjusting device which is to be adjusted is normalized by evaluating the parameter of the transformed signal for at least one of the two mother wavelets. This at least one mother wavelet allows precise evaluation of the present position from this blocking. In addition to instances of blocking, other significant characteristics of the adjusting movement are also used for normalization, for example a known restriction within the adjusting path.

To normalize the position of the component to be adjusted on one of the stops, another advantageous development involves the time scale range of the transformed signal being used to ascertain blocking of the adjusting movement on at least one mechanical stop in the adjusting device. In this case, this stop has a spring rate which is characteristic of it and which is ascertained by the control apparatus and evaluated for normalization.

The various evaluation functions make it possible to use the combined evaluation of a plurality of scales of the transformed signal to distinguish between an instance of trapping and blocking on one of the mechanical stops. By way of example, the parameter of a scale is compared with the threshold value, and the comparison result is verified with the evaluation of the parameter of a further scale. This verification, which is effected by ANDing the respective evaluation results, for example, reduces the probability of the adjusting device reacting incorrectly to external influences.

In another preferred development, the signal is dependent on a drive current for the drive in the adjusting device. The signal profile of the drive current, which is ascertained by means of a current sensor, for example, is characteristic of the different operating states, such as the startup behavior, the rated operation, the braking response or the behavior in the event of blocking or restriction. In the case of an increased torque, for example on account of a restriction, the motor current increases significantly. The gradient of increase has frequency components which can be evaluated particularly by the wavelet transformation—as stated previously—in order to identify particularly, an instance of trapping and to control the adjustment accordingly.

In addition to the detection of an instance of trapping, the drive current is also advantageously evaluated for the purpose of finding the position of the part of the adjusting device which is to be adjusted. To this end, one, advantageous development involves the signal being dependent on a ripple in the drive current, particularly one which is caused by the commutation of the drive. In this context, the frequency of the current ripple is a function of speed, groove number and pole number, i.e. the algorithm for evaluation advantageously records a speed range from the stationary motor to the rated speed in order to detect all the extremes of the current ripple.

Advantageously, a position within the adjusting path of the adjusting device is determined from the transformed signal. To this end, the ascertained ripples are counted in order to increment or decrement the present position. To determine the present position relative to the real position of the part of the adjusting device which is to be adjusted as accurately as possible, it is necessary to record the ripple in the drive current as accurately as possible.

To this end, one particularly advantageous embodiment involves a position being found by evaluating a position parameter of the transformed signal as a parameter by counting the excess above and/or shortfall below one or more position threshold values. In this context, the threshold value(s) need(s) to be stipulated such that the signal which is dependent on the ripple in the drive current fall short of and/or exceeds this threshold value or these threshold values when the drive motor is operated.

Preferably, at least one threshold value is adapted. The adaptation preferably takes place on the basis of particular measured values and/or prescribed parameters. In this case, one advantageous development provides for at least one threshold value to be adapted if a ripple has not previously been identified. From the preceding ripples, a ripple is then expected within a particular time interval. If the ripple is not detected within the time interval then, in line with one advantageous embodiment, the sensitivity of detection is increased by adapting the threshold value(s). The adaptation is achieved by overwriting the register entries which represent the threshold values in a microcontroller, for example. If two threshold values are used as a window comparator, for example, then the window is preferably reduced in order to increase sensitivity.

An alternative, which may also be combined, for adapting the threshold values may advantageously be implemented by adapting the at least one threshold value on the basis of a particular surface integral for the values of the parameter. In this case, the surface integral allows high-frequency noise components in a useful signal to be filtered out. In addition, a surface integral is also advantageously used to determine the ripple by comparing the present value of the surface integral with one or more threshold values.

Preferably, the at least one threshold value is adapted on the basis of the drive movement and/or a mode of operation of the adjusting device and/or on the basis of one or more further parameters of the motor vehicle. The dependence on the drive movement is caused by the behavior of the drive motor, particularly in the startup behavior, the even adjustment, the braking response or the adjustment into a stop, for example. The mode of operation is characterized by automatic cycles, manual adjustment, inching duty or normalization cycles, for example, and is stored as a control parameter in the microcontroller. The parameter of the motor vehicle is the ignition switch position or the measured signal from an acceleration sensor, for example.

In another preferred development, a position is found by evaluating a position parameter of the transformed signal by counting a position increment when the position parameter exceeds and/or falls short of a lower position threshold value and an upper position threshold value. In this case, the position parameter is dependent on the ripple in the drive current. In particular, the ripple in the drive signal is transformed into a band in scale time range. The upper and lower position threshold values preferably need to be exceeded and/or undershot in succession in order to detect a position increment which is to be counted.

In one advantageous embodiment of this development, a position increment is counted only if the excess above and/or shortfall below the lower position threshold value and the upper position threshold value occurs within a particular time period. The time period is used to stipulate a signal gradient for which a position increment is detected. In addition to this signal increase, a surface integral is preferably evaluated. In this case, the position increment can be detected using a comparison between the value of the surface integral and a surface integral threshold value.

In another advantageous embodiment, values of a position parameter for determining a ripple in the signal are evaluated within a time interval. In this case, the time interval is preferably disposed around a ripple which is to be expected. Within this interval, the signal values of the transformed signal can be evaluated, which allows the processing power to be reduced, for example. Preferably, a breadth for the time interval is adapted on the basis of the amplitude of the position parameter. In the case of very noisy signals, this allows more reliable evaluation, whereas when the signal-to-noise ratio is high the processing power used is reduced.

An embodiment which can also be combined with the adaptation of the breadth of the interval makes it possible, when the adjusting movement starts, for the first boundary occurring in the time interval to be adapted independently of the second boundary of the time interval. This advantageously results in a reaction to an acceleration response or to a braking response by the adjusting device.

In addition, provision may advantageously be made for the timing of a ripple identified within the time interval to be corrected if a discrepancy from the time sequence of preceding or succeeding ripples is ascertained.

Exemplary embodiments of the invention are explained in more detail below with reference to a drawing, in which:

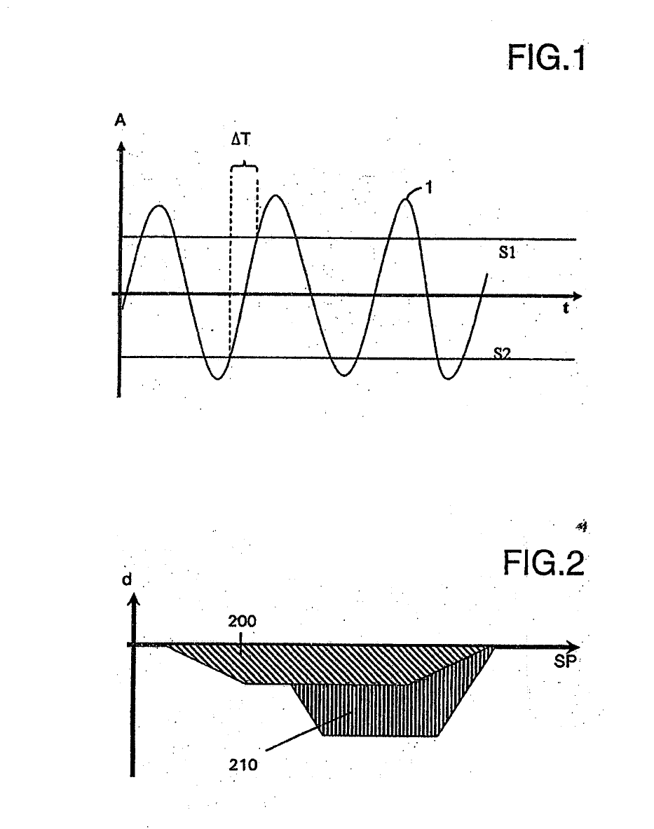

FIG. 1 shows a ripple component of a current signal in a mechanical commutated electric motor,

FIG. 2 shows a schematic illustration of a transformed signal, which is dependent on the movement of an electric motor, for different spring rates of a trapped object or body part,

FIG. 3 shows a schematic illustration of an electric motor,

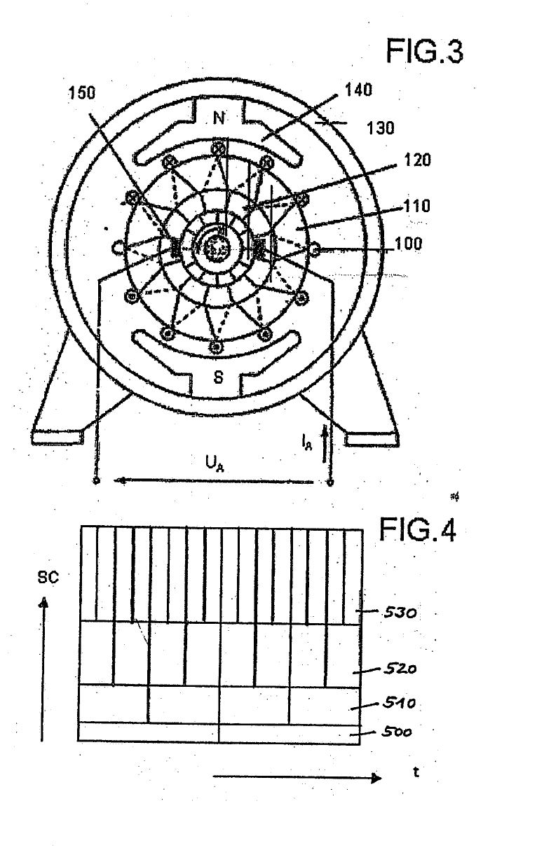

FIG. 4 shows various scales of a wavelet transformation,

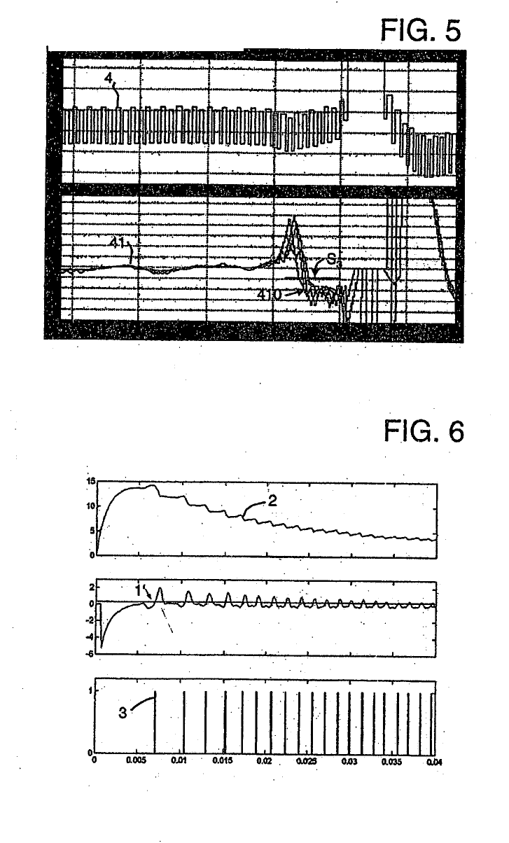

FIG. 5 shows a measured signal from a Hall sensor in the time range and in the scale range, and

FIG. 6 shows a measured signal for a motor current and also the evaluation of the wavelet transform of the measured signal using a threshold value.

First of all, the text below provides a more detailed explanation of the wavelet transformation used in the exemplary embodiments. The conventional method of spectral analysis is Fourier transformation (FT). Problems arise when the Fourier transformation is discretized, since digital Fourier transformation is defined only for periodic signals, i.e. frequency changes and inconstancies can be described only with difficulty.

Using what is known as wavelet transformation (WT), which is integral transformation with a locally compact medium, these problems of Fourier transformation can be overcome. In this case, the mapping properties of wavelet transformation are dependent on a selection of the wavelet core and the wavelet base. Continuous wavelet transformation uses shifts and expansions in a particular family of functions, known as wavelet bases, in order to transform functions, i.e. the transformation uses functions of the form

$${ψ}_{a , b} = \frac{1}{\sqrt{\vert a \vert}} ψ ( \frac{t - b}{a} )$$

with a,bεIR,a≠0
in order to examine signals. In the case of continuous wavelet transformation, the expansions and shifts are varied continuously over the set of real numbers.

Wavelets are quadratically integratable functions in the L₂(|) space, i.e.

$${‖ ψ ‖}^{2} = {\int }_{- ∞}^{∞} {\vert ψ ( t ) \vert}^{2} d t < ∞$$

can be applied.

In addition,

$${\int }_{- ∞}^{∞} ψ ( t ) d t = 0$$

can be written.

So that a wavelet represents a wavelet base, the following admissibility condition needs to be met:

$$0 < {c}_{ψ} := 2 π {\int }_{- ∞}^{∞} \frac{{\vert \hat{ψ} ( w ) \vert}^{2}}{\vert w \vert} d w < ∞$$

In this case, ψ(w) is the Fourier transform ψ(t). If a wavelet meets this condition then the function can be recovered from its Fourier transform.

The continuous wavelet transformation of a function s(t) εL₂(|) can be described by the following expression:

$$W ( a , b ) = \frac{{\vert a \vert}^{- 1 / 2}}{\sqrt{{c}_{ψ}}} \int ψ ( \frac{t - b}{a} ) s ( t ) d t$$

Just from this coarse outline, it is possible to see a few properties of the wavelet transformation. To clarify its mode of action, a wavelet ψ with a compact medium is assumed. The parameter b shifts the wavelet, so that the transform contains local information from s around the time t=b. The parameter a controls the magnitude of the range of influence, and for a around zero the wavelet transform zooms ever more sharply onto t=b. The inverse wavelet transformation is then:

$$s ( t ) = \frac{1}{{c}_{ψ}} {\int }_{- ∞}^{∞} {\int }_{- ∞}^{∞} W ( a , b ) ψ ( t ) \frac{d a d b}{{a}^{2}}$$

The description of the continuous wavelet transformation in the preceding section served primarily to explain the wavelet transformation. In practice, however, the general equation now needs to be discretized for efficient use of the transformation.

So that transformation is not required over all numbers continuously, it is useful to assign the parameters a and b specific values in order to define the base for the wavelet. The most common assignment is a dyadic variation of the parameters: a=2^{-j} and b=k 2^{-j}, where k and j are integer numbers. This specific assignment produces the following wavelets:

$${ψ}_{j , k} = ψ ( \frac{t - k \cdot {2}^{- j}}{{2}^{- j}} )$$

These wavelets produce a dyadic wavelet transformation:

$$W ( {2}^{- j} , k \cdot {2}^{- j} ) = \frac{1}{\sqrt{{2}^{- j}}} \int ψ ( \frac{t - k \cdot {2}^{- j}}{{2}^{- j}} ) s ( t ) d t$$

If the integral is now replaced by a sum, the following discrete transformation (DWT) is obtained:

$$ω ( {2}^{- j} , k \cdot {2}^{- j} ) = \frac{1}{\sqrt{{2}^{- j}}} \sum ψ ( \frac{n}{{2}^{- j}} - k ) s ( n )$$

The discrete wavelet transformation can now be used to represent any desired function, in a similar manner to with Fourier series, with wavelet series.

Preferably, multiscale analysis (MSA) on the basis of dyadic wavelets is used. For multiscale analysis, the starting point is splitting a signal s(t) comprising a subspace V₋₁ of the L₂(|) into its high- and low-frequency components. The smooth component is described by an orthogonal projection P₀s onto a relatively small space V₀, which contains the smooth function V₋₁. The orthogonal complement V₀ in V₋₁ is denoted by W₀, which comprises the rough elements. The projection from s onto W₀ is then Q₀s. It is thus possible to write:

s=P₀s+Q₀s

V₋₁=V₀ [symbol] W₀

A similar procedure is now used for P₀s, i.e. P₀s is also in turn split into subspaces V₁ and W₁, which respectively contain the smooth and rough elements. What is obtained is:

s=P₁s+Q₁s+Q₀s

This equation can be understood as decomposing a signal into frequency bands of high frequencies and into a frequency mix of low frequencies. This decomposition process can be described mathematically using multiscale analysis. The spaces Vₘ are scaled functions of the basic space V₀, which is unfolded by translating a function φ, the scaling function. This scaling function satisfies a scaling equation:

$$ϕ ( t ) = \sqrt{2} {\sum }_{k ∈ Z} {h}_{k} ϕ ( 2 t - k )$$

This equation holds the key to constructing both orthogonal wavelet bases and fast algorithms. The connection between scaling functions and wavelets is shown by the following equations:

$$ψ ( t ) = \sqrt{2} {\sum }_{k ∈ Z} {g}_{k} ϕ ( 2 t - k )$$

$$g ( k ) = {( - 1 )}^{k} {h}_{1 - k}$$

FIG. 4 schematically shows such decomposition using multiscale analysis. In this case, the scales SC comprise different time intervals. The scale 530 corresponds to high-frequency signal components, whereas the scale 500 comprises essentially the very low-frequency signal components. The intermediate scales 520 and 510 relate to further frequency components of the transformed signal. FIG. 4 illustrates that the low-frequency signal components of the scale 500 are transformed over a greater period of time than the scale 530 of the high-frequency signal components. In particular, the surface contents of the individual signal components are correlated to one another.

For practical use of the wavelet transformation, a fast algorithm is required in order to apply the discrete wavelet transformation effectively. The central aid for this purpose is the multiscale analysis described in the previous section.

A function s in V₀ has an evolution in the form

$$s ( t ) = {\sum }_{k ∈ Z} {c}_{k}^{0} ϕ ( t - k )$$

with the real evolution coefficient:

c⁰={cₖ⁰|kεZ}

As previously, ψ denotes the orthogonal wavelet associated with φ. It is now possible to start calculating the discrete wavelet transformation, i.e. evaluating the scalar products

\sqrt{c[ψ]}ω(2^{-j},k·2^{-j})= [symbol] s,ψⱼₖ [symbol] , jεIN₀, kεZ

### In this regard, the labels

dₖ^{j}= [symbol] f,ψⱼₖ [symbol] _{L}_{²}, d^{j}={dₖ^{j}|kεZ}εl²(Z)

cₖ^{j}= [symbol] f,φⱼₖ [symbol] _{L}_{²}, c^{j}={cₖ^{j}|kεZ}εl²(Z)

are introduced. Using the scaling equation, the following representations are obtained:

$${d}_{k}^{j} = {〈 f , {ψ}_{jk} 〉}_{{L}^{2}} = {\sum }_{𝓁 ∈ Z} {g}_{𝓁} {〈 s , {ϕ}_{j - 1 , 2 k - 1} 〉}_{{L}^{2}} = {\sum }_{𝓁 ∈ Z} {g}_{𝓁 - 2 k} {c}_{𝓁}^{j - 1}$$

$${c}_{k}^{j} = {〈 f , {ψ}_{jk} 〉}_{{L}^{2}} = {\sum }_{𝓁 ∈ Z} {h}_{𝓁} {〈 s , {ϕ}_{j - 1 , 2 k - 1} 〉}_{{L}^{2}} = {\sum }_{𝓁 ∈ Z} {h}_{𝓁 - 2 k} {c}_{𝓁}^{j - 1}$$

This gives the decomposition algorithm. Starting from the sequence C⁰, the discrete wavelet decomposition can be calculated recursively through discrete convolution. In addition, another decomposition code with further support points between the individual calculations is possible.

Selecting the appropriate wavelet for rapid and effective evaluation of the generated signals allows optimization for specific applications. A relatively simple wavelet will now be chosen, the Haar wavelet. Firstly, this is the simplest wavelet with just two respective coefficients for the scaling wavelet decomposition. Secondly, other more complicated wavelets can also be used to attain transformation of the generated signals.

The Haar wavelet is described by the following formula:

$$ψ ( t ) = \{ \begin{matrix}1 & : & t \leq 1 / 2 \\ - 1 & : & 1 / 2 \leq t \leq 1 \\ 0 & : & else\end{matrix}$$

The associated characteristic scaling function is:

$$ϕ ( t ) = \{ \begin{matrix}1 & : & 0 \leq t \leq 1 \\ 0 & : & else\end{matrix}$$

The profile of the scaling function is thus stipulated. For the filter coefficients hₖ and gₖ, the following expressions apply:

$${h}_{k} = \{ \begin{matrix}\frac{1}{\sqrt{2}} & : & k = 0 or k = 1 \\ 0 & : & else\end{matrix} \\ {g}_{k} = \{ \begin{matrix}\frac{1}{\sqrt{2}} & : & k = 0 \\ - \frac{1}{\sqrt{2}} & : & k = 1 \\ 0 & : & else\end{matrix}$$

To clarify a trapping protection function, FIG. 5 shows several signal profiles. The top part of FIG. 5 shows a signal which is dependent on the rotation speed of an electric motor in an adjusting device in a motor vehicle. This generated signal 4 is produced by measuring the time interval between edges which are dependent on an angle of rotation of the rotating motor. These are caused by virtue of an annular magnet, which in this case has four poles, being sensed by a Hall sensor and by virtue of the Hall voltages measured by the Hall sensor changing on the basis of the annular magnet's respective polarity associated with the angle of rotation. The different size of the four segments means that the rotating motor's movement, which is initially constant, exhibits a rectangular profile, correlating to the segment sizes, for the measured times between the individual changes in the polarities of the annular magnet.

The bottom part of FIG. 5 shows four transformed signals 41 which have been obtained from the generated signal 4 in the top part of FIG. 5. In this case, each transform has an associated pole segment of the annular magnet. The transformed signal 41 is essentially constant for the initially essentially constant speed of rotation of the electric motor in the adjusting device in the motor vehicle. Before the threshold value S3 is undershot, it is also possible to identify a brief acceleration, caused by the mechanical system, through the four transformed curves. In the region 410 of the transformed signal, the transformed signal values of all four segments are below the threshold value S3. This situation can be detected as an instance of trapping by a control apparatus, and the drive can be actuated in the opposite direction in the subsequent method step, so that the adjusting movement is reversed in the instance of trapping. The measured values and the transformed signal 41 for the movement in the opposite direction are shown in the rear marginal region of FIG. 5.

FIG. 2 shows two different curves 200 and 210 which are associated with different spring rates in the event of blocking. In the purely schematic illustration in FIG. 2, the scale values D are plotted against the samples SP progressing over time. In this regard, FIG. 2 shows 2 curves, with the curve 200 correlating to a spring rate of 10 N/mm and the curve 210 correlating to values at a spring rate of 65 N/mm. The curves 200 and 210 thus relate to a hard and a relatively soft trapped object.

The signals which are dependent on the movement of the adjusting apparatus are transformed using the wavelet transformation and produce the schematically illustrated curve profiles for the two instances of trapping which are shown in FIG. 2. The generated signal's signals which are dependent on the adjusting movement may be, by way of example, the time intervals 4 (shown in the top part of FIG. 5) between a plurality of Hall edges of a Hall sensor signal interacting with the annular magnet described above.

In addition to Hall signals, other sensor signals may alternatively be used which are dependent on the adjusting movement of the adjusting device. Advantageously, a drive current for an electric motor in the adjusting device is used to evaluate the drive moment of the adjusting device. An electric motor of this kind is shown in FIG. 3 by way of example. FIG. 3 shows a simple motor model with two poles. The stator made of solid iron bears an electromagnet or—as in this case—a permanent magnet which provides the circulation which is required to set up a magnetic field.

The primary poles N and S are extended inward by what are known as pole shoes 140 in order to pick up the greatest possible number of armature windings 100. The magnetic inference is ensured by the housing or by the yoke ring 130. An iron body layered from electrical steel sheets surrounds the shaft of the motor. The magnetic circuit is therefore—apart from the air gap between the armature 110 and the primary pole 140 which is required for the motor to rotate—made of iron. The conductor rods together with the connections form the armature coils 100. The rotating part is referred to as the armature 110, already mentioned above.

So that a torque is produced in the stator field by the current-carrying conductors 100, the current direction needs to be switched during rotation of the armature 110 when the pole region N or S changes in the armature conductor 100. This task is undertaken by a current-reversing key, which is also called a commutator. This comprises mutual insulated laminae or copper segments and is permanently connected to the shaft. The coils in the armature winding 100 have their start and end permanently connected to the individual segment. Carbon, or, in smaller motors, metal brushes 150, is used to supply current to the armature winding 100. In this arrangement, the brushes 150 and the commutator form a sliding contact.

When the conductor through the neutral zone changes, its current direction is changed. The commutator is therefore used as a mechanical switch. The mechanical commutation of the basic electric motor illustrated before generates a ripple in the drive current, with the distance between these maxima and minima correlating to an angle of rotation of the electric motor.

The top part of FIG. 6 shows a motor current during the startup phase of the adjusting device. In this case, the motor current 2 has a ripple. The ripple in this signal is maintained even if this generated signal 2 is transformed using wavelet transformation.

The wavelet transform is shown in the central region of FIG. 6. The signal 1 of the wavelet transform clearly shows that a ripple in this signal is also maintained in the transformed region and can be evaluated. To this end, the signal is evaluated using the threshold value shown, by virtue of an output signal (shown in the bottom part of FIG. 6) from a threshold value switch being produced when the transformed signal 1 exceeds the threshold value. This output signal 3 from the threshold value switch is a binary signal which correlates in time to the threshold being exceeded (shown previously) by the transformed signal 1. Accordingly, the intervals between the output signal 3 from the threshold value switch correlate to angles of rotation of the electric motor.

To obtain an improved evaluation of the transformed signal 1, FIG. 1 now shows that the transformed signal—denoted by 1 here—needs to exceed both a lower threshold value S2 and an upper threshold value S1 in order for a ripple to be identified as valid. In this case, the lower and upper threshold values S2 and S1 need to be exceeded within a prescribed time period ΔT so that the ripple in the signal can be identified as valid. In this context, FIG. 1 is a purely schematic illustration of the transformed signal 1, with the amplitude of the transformed signal A being shown plotted over time t. The output signal in the lower region of FIG. 6 from the threshold value switch, which signal may be dependent on one or—as FIG. 1 shows—more two-threshold values for evaluation, may in turn be used to detect an instance of trapping. In this regard, the time interval between two output signals 3 which take the value 1 is measured and in turn is supplied to wavelet transformation. This can occur because the time intervals between the output signals 3 from the threshold value switch are comparable with the time intervals between the Hall sensor signals in the top part of FIG. 5. The ripple in the drive current can be used to determine the instantaneous speed of the drive movement. In addition, a change in position can be determined by counting the individual identified ripples, for example.

Preferably, as an alternative or in combination, the instantaneous current or the instantaneous change in current of the motor current is evaluated in addition to the ripple in the drive current for the purpose of detecting blocking of the adjustment. In this context, the relationship between the instantaneous motor current and the torque applied by the motor is used. If the motor current increases significantly, for example, then the torque from the motor is increased proportionately. In addition, the slowing of the motor speed can be evaluated in combination by increasing the time intervals between identified ripples in the drive current, and can be used to detect blocking, particularly an instance of trapping.

Preferably, the detection of trapping by means of wavelet transformation is used for low spring rates of trapped objects or body parts. In this case, use is particularly advantageous particularly for spring rates <60 Nm and particularly less than 10 Nm. With particular preference, the transformed signal is additionally integrated in order to filter out jolt and impact forces. To implement detection of trapping, the integration value obtained from the integration is compared with an integration threshold value.

In one particularly advantageous development of the invention, two different ascertainments of an instance of trapping take place simultaneously. In this case, the measured data are evaluated in parallel firstly using the wavelet transformation and secondly using an algorithm which evaluates the measured data in the time range. In this context, the evaluation in the time range is designed for greater spring rates than the evaluation using wavelet transformation.

### LIST OF REFERENCE SYMBOLS

A Amplitude
ΔT Time interval, time period
S1, S2, S3 Threshold value
d Amplitude
SP Sampling operations
t Time
N, S Magnetic poles
U_{A} Motor voltage
I_{A} Motor current
SC Scale
1, 1′ Transformed signal
2 Generated signal
3 Output signal from a threshold value switch
4 Speed-dependent, in particular generated, signal, Hall time in seconds
41 Transformed signal, wavelet transform of the individual Hall segment times
410 Instance of blocking, instance of trapping
100 Armature winding
110 Set of armature laminations
120 Commutator
130 Yoke ring
140 Primary pole
150 Brushes
200 Transformed signal for spring rate 10 N/mm
210 Transformed signal for spring rate 65 N/mm
500, 510, 520, 530 Scale

1. Method for controlling an adjusting device in a motor vehicle, particularly a motor vehicle seat adjuster, a window lifter or a door opener,
where a signal for a drive speed of a drive in the adjusting device is transformed, and
where the drive is stopped and/or the drive direction is reversed if it is determined that an object or body part is trapped on the basis of a parameter in the time scale range of the transformed signal.

2. Method according to claim 1,
characterized in that a window function is used for the transformation.

3. Method according to claim 2,
characterized in that the window function, particularly the boundaries of the window, is adapted.

4. Method according to claim 2 or 3,
characterized in that the number of windowing operations is adapted, particularly further window functions are added.

5. Method according to one of claims 1 to 4,
characterized in that the signal is transformed using a wavelet transformation.

6. Method according to one of claims 1 to 5,
characterized in that at least one parameter is determined by evaluating one or more scales.

7. Method according to claim 6,
characterized in that the parameter is a measure of a component of one or more scales in the generated signal.

8. Method according to claim 7,
characterized in that the parameter is a measure of this component in relation to a time unit.

9. Method according to one of claims 1 to 6,
characterized in that different spring rates for the mechanical system of the adjusting device, particularly on different scales, are evaluated.

10. Method according to claim 6 or 9,
characterized in that one or more inherent frequencies of one or more gears in the mechanical system of the adjusting device, particularly on different scales, are evaluated.

11. Method according to one of claims 6 to 10,
characterized in that one or more scales are back-transformed in order to reduce, in particular, ascertained noise signals for particular scales.

12. Method according to one of claims 1 to 11,
characterized in that a characteristic of the parameter for the instance of trapping is identified.

13. Method according to claim 12,
characterized in that the characteristic of the parameter is a characteristic of the time profile of the parameter of the transformed signal.

14. Method according to claim 13,
characterized in that the characteristic of the time profile is a value for a change in the parameter over time.

15. Method according to one of claims 12 to 14,
characterized in that the characteristic is a value for integration of the parameter with respect to time.

16. Method according to one of claims 12 to 15,
characterized in that the characteristic is an excess above and/or a shortfall below one or more threshold values by the parameter and/or a change in the parameter over time and/or the value of the integration of the parameter with respect to time.

17. Method according to one of claims 12 to 14,
characterized in that the characteristic is a value for a transform of the parameter.

18. Method according to claim 16,
characterized in that at least one threshold value is adapted.

19. Method according to claim 18,
characterized in that the at least one threshold value is adapted on the basis of a particular surface integral for the values of the parameter.

20. Method according to claim 18,
characterized in that the at least one threshold value is adapted on the basis of the drive movement and/or on the basis of a mode of operation of the adjusting device and/or on the basis of one or more further parameters of the motor vehicle.

21. Method according to one of claims 18 to 20,
characterized in that the at least one threshold value is adapted on the basis of
one or more spring rates for the mechanical system of the adjusting device,
a measured force due to weight, acting on the mechanical system of the adjusting device,
a measured temperature of the mechanical system and/or of the drive in the adjusting device,
a measured or determined (PWM) supply voltage for the drive,
a present position of the part of the adjusting device which is to be adjusted, or
a combination of the aforementioned variables.

22. Method according to one of claims 1 to 21,
characterized in that a mother wavelet and/or a father wavelet from the wavelet transformation is formed or adapted on the basis of the signal and/or a profile of the signal when the adjusting movement is blocked.

23. Method according to claim 22,
characterized in that when the adjusting movement is blocked at least two different mother wavelets from the wavelet transformation are used for at least two transformations into the time scale range.

24. Method according to one of claims 22 and 23,
characterized in that the mother wavelet and/or the father wavelet is adapted as a seal wavelet to suit the profile of the generated signal for adjusting the part to be adjusted into a seal.

25. Method according to one of claims 22 and 23,
characterized in that the mother wavelet and/or the father wavelet is adapted as a block wavelet to suit the profile of the generated signal for adjusting the part to be adjusted onto a mechanical stop.

26. Method according to one of claims 22 and 23,
characterized in that the mother wavelet and/or the father wavelet is adapted as a standard wavelet to suit the profile of the generated signal for the instance of one or more body parts being trapped.

27. Method according to one of claims 22 to 26,
characterized in that the blocking prompts changeover between the at least two mother wavelets and/or father wavelets.

28. Method according to one of claims 22 to 26,
characterized in that—particularly in the case of the blocking—the present position of the part of the adjusting device which is to be adjusted is normalized by evaluating the parameter of the transformed signal for at least one of the two mother wavelets and/or father wavelets.

29. Method for controlling an adjusting device in a motor vehicle, particularly according to one of the preceding claims, in which
a signal generated on the basis of a drive movement of a drive in the adjusting device is transformed,
a time scale range of the transformed signal is used to ascertain blocking of the adjusting movement on at least one mechanical stop in the adjusting device, and
the drive is actuated on the basis of the ascertainment of the at least one mechanical stop.

30. Method according to one of the preceding claims,
characterized in that a combined evaluation of a plurality of scales of the transformed signal is used to distinguish between an instance of trapping and blocking on one of the mechanical stops.

31. Method according to one of the preceding claims,
characterized in that the signal is dependent on a drive current for the drive in the adjusting device.

32. Method for controlling an adjusting device in a motor vehicle, particularly according to one of the preceding claims, in which a drive is controlled on the basis of an ascertained adjusting position and/or an ascertained adjusting speed, where
a signal generated on the basis of a ripple in a drive current for a drive in the adjusting device is transformed, and
the adjusting position and/or the adjusting speed is ascertained by comparing a parameter in the time scale range of the transformed signal with one or more threshold values and counting the excess above and/or shortfall below at least one threshold value.

33. Method according to claim 32,
characterized in that the ripple in the drive current is caused by the commutation in the drive.

34. Method according to claim 32,
characterized in that
the generated signal is additionally generated on the basis of a torque for the drive in the adjusting device and is transformed, and
the drive is stopped on the basis of position and/or the drive direction is reversed if the trapping of an object or body part is determined on the basis of the parameter and/or a further parameter in the time scale range of the transformed signal.

35. Method according to at least claim 32,
characterized in that at least one threshold value is adapted.

36. Method according to claim 35,
characterized in that at least one threshold value is adapted if a ripple has not been identified beforehand.

37. Method according to one of claims 35 and 36,
characterized in that the at least one threshold value is adapted on the basis of a particular surface integral for the values of the parameter.

38. Method according to one of claims 35 to 37,
characterized in that the at least one threshold value is adapted on the basis of the drive movement and/or on the basis of a mode of operation of the adjusting device and/or on the basis of one or more further parameters of the motor vehicle.

39. Method according to at least claim 32,
characterized in that a position increment is counted only if the successive excess above a lower threshold value and/or an upper threshold value and/or the successive shortfall below an upper threshold value and a lower threshold value occurs within a particular time period.

40. Method according to one of claims 32 to 39,
characterized in that values of the parameter, particularly of the transformed signal, are evaluated within a time interval in order to determine a, particularly an expected, wave in the signal.

41. Method according to claim 40,
characterized in that a breadth of the time interval is adapted on the basis of the amplitude of the parameter, particularly of the transformed signal.

42. Method according to claim 40,
characterized in that when the adjusting movement starts, the first boundary occurring in the time interval is adapted independently of the second boundary of the time interval.

43. Method according to one of claims 40 to 42,
characterized in that the timing of a ripple identified within the time interval is corrected if a discrepancy from the time sequence of preceding or succeeding ripples is ascertained.

44. Control apparatus for an adjusting device in a motor vehicle, having
a sensor for generating a signal associated with a drive speed for a drive in the adjusting device,
a processor which has functions for transforming the signal and stopping the drive movement when an object or body part is trapped on the basis of a parameter in the time scale range of the transformed signal, and
a power driver, connected to the processor, for controlling a drive current for the instance of trapping.

45. Control apparatus according to claim 44,
characterized by a window function for the transformation.

46. Control apparatus according to claim 45,
characterized by an adaptation function in the processor set up for this purpose for adapting the boundaries of the window of the window function.

47. Control apparatus according to one of claims 45 and 46,
characterized in that the processor is set up to adapt, particularly to add, the number of windowing operations.

48. Control apparatus according to one of claims 44 to 47,
characterized in that the transformation is a wavelet transformation.

49. Control apparatus according to one of claims 44 to 48,
characterized in that for the purpose of stopping the drive movement the processor is set up to evaluate at least one parameter of one or more scales.

50. Control apparatus according to one of claims 44 to 49,
characterized in that the parameter is a measure of a component of one or more scales in the generated signal.

51. Control apparatus according to claim 50,
characterized in that the parameter is a measure of this component in relation to a time unit.

52. Control apparatus according to at least claim 49,
characterized in that the processor is set up to evaluate different spring rates for the mechanical system of the adjusting device, particularly on different scales.

53. Control apparatus according to one of claims 49 and 52,
characterized in that the processor is set up to evaluate one or more inherent frequencies of one or more drives in the mechanical system of the adjusting device, particularly on different scales.

54. Control apparatus according to one of claims 49 to 53,
characterized in that the processor is set up to back-transform one or more scales in order to reduce, in particular, ascertained noise signals for particular scales.

55. Control apparatus according to one of claims 44 to 54,
characterized in that the processor is set up to identify a characteristic of the parameter for the instance of trapping.

56. Control apparatus according to claim 55,
characterized in that the characteristic of the parameter is a characteristic of the time profile of the parameter of the transformed signal.

57. Control apparatus according to claim 56,
characterized in that the characteristic of the time profile is a value for a change in the parameter over time.

58. Control apparatus according to one of claims 55 to 57,
characterized in that the characteristic is an excess above and/or a shortfall below one or more threshold values by the parameter and/or a change in the parameter over time.

59. Control apparatus according to one of claims 55 to 58,
characterized in that the characteristic is a value for a transform of the parameter.

60. Control apparatus according to claim 58,
characterized in that the processor is set up to adapt at least one threshold value.

61. Control apparatus according to claim 60,
characterized in that the processor is set up to adapt at least one threshold value on the basis of a particular surface integral for the values of the parameter.

62. Control apparatus according to claim 60,
characterized in that the processor is set up to adapt the at least one threshold value on the basis of the drive movement and/or on the basis of a mode of operation of the adjusting device and/or on the basis of one or more further parameters of the motor vehicle.

63. Control apparatus according to one of claims 60 to 62,
characterized in that the processor is set up to adapt the at least one threshold value on the basis of
one or more spring rates for the mechanical system of the adjusting device,
a measured force due to weight, acting on the mechanical system of the adjusting device,
a measured temperature of the mechanical system and/or of the drive in the adjusting device,
a measured or determined (PWM) supply voltage for the drive,
a present position of the part of the adjusting device which is to be adjusted, or
a combination of the aforementioned variables.

64. Control apparatus according to at least claim 48,
characterized in that the processor is set up to adapt a mother wavelet and/or a father wavelet from the wavelet transformation on the basis of the signal and/or a profile of the signal when the adjusting movement is blocked.

65. Control apparatus according to claim 64,
characterized in that the processor is set up to transform into the time scale range at least two different mother wavelets and/or father wavelets from the wavelet transformation, particularly when the adjusting movement is blocked.

66. Control apparatus according to one of claims 64 and 65,
characterized by a seal wavelet as mother wavelet and/or father wavelet which has been adapted to suit the profile of the generated signal for adjusting the part to be adjusted into a seal.

67. Control apparatus according to one of claims 64 and 65,
characterized by a block wavelet as mother wavelet and/or father wavelet which has been adapted to suit the profile of the generated signal for adjusting the part to be adjusted onto a mechanical stop.

68. Control apparatus according to one of claims 64 and 65,
characterized by a standard wavelet as mother wavelet and/or father wavelet which has been adapted to suit the profile of the generated signal for when one or more body parts are trapped.

69. Control apparatus according to one of claims 64 to 68,
characterized in that the processor is set up to change over between the at least two mother wavelets and/or father wavelets for the instance of blocking.

70. Control apparatus according to one of claims 64 to 69,
characterized in that the processor is set up to normalize the present position of the part of the adjusting device which is to be adjusted, with the operation of the processor including evaluation of the parameter of the transformed signal for at least one of the two mother wavelets and/or father wavelets, particularly for the instance of blocking.

71. Control apparatus for an adjusting device in a motor vehicle, particularly according to one of the preceding claims, having
a sensor for generating a signal which is dependent on a drive movement of a drive in the adjusting device,
a processor which has functions for transforming the signal and ascertaining blocking on a mechanical stop using a parameter in the time scale range of the transformed signal, and
a power driver, connected to the processor, for controlling a drive current for the instance of blocking.

72. Control apparatus according to one of the preceding claims,
characterized in that the processor is set up for the combined evaluation of a plurality of scales of the transformed signal in order to distinguish between an instance of trapping and blocking on one of the mechanical stops.

73. Control apparatus according to one of the preceding claims,
characterized in that the signal is dependent on a drive current for the drive in the adjusting device.

74. Control apparatus for an adjusting device in a motor vehicle, particularly according to one of the preceding claims, having
a current sensor for generating a signal which is dependent on a ripple in a drive current for the adjusting device,
a processor which is set up to transform the signal, to ascertain an adjusting position and/or an adjusting speed from the parameter in the time scale range of the transformed signal and to control the drive on the basis of the ascertained adjusting position, and
a power driver, connected to the processor, for controlling a drive current.

75. Control apparatus according to one of the preceding claims,
characterized in that the processor includes the function for finding a position for the part of the adjusting device which is to be adjusted within the adjusting path from the transformed signal.

76. Control apparatus according to claim 75,
characterized in that for the purpose of position finding the processor is set up to evaluate a parameter of the transformed signal by counting the excess above and/or shortfall below one or more position threshold values by values of the parameter.

77. Control apparatus according to claim 76,
characterized in that the processor has the function of adapting at least one threshold value.

78. Control apparatus according to claim 77,
characterized in that the processor has the function of adapting the at least one threshold value on the basis of an unidentified ripple.

79. Control apparatus according to one of claims 77 and 78,
characterized in that the processor is set up to adapt the at least one threshold value on the basis of a particular surface integral for the values of the parameter.

80. Control apparatus according to one of claims 77 to 79,
characterized in that the processor is set up to adapt the at least one threshold value on the basis of the drive movement and/or on the basis of a mode of operation of the adjusting device and/or on the basis of one or more further parameters of the motor vehicle.

81. Control apparatus according to claim 76,
characterized in that for the purpose of position finding the processor is set up to evaluate a position parameter of the transformed signal, with the processor being set up to count a position increment on the basis of the shortfall below and/or excess above a lower position threshold value and an upper position threshold value.

82. Control apparatus according to claim 81,
characterized in that the processor is set up to count a position increment only if the excess above and/or shortfall below the lower position threshold value and the upper position threshold value occurs within a particular time period.

83. Control apparatus according to one of claims 77 to 82,
characterized in that the processor is set up to evaluate values of a position parameter in order to determine a wave in a ripple in the signal within a time interval.

84. Control apparatus according to claim 83,
characterized in that a breadth of the time interval can be adapted on the basis of the amplitude of the position parameter.

85. Control apparatus according to claim 83,
characterized in that when the adjusting movement starts, the first boundary occurring in the time interval can be adapted independently of the second boundary of the time interval.

86. Control apparatus according to one of claims 83 to 85,
characterized in that the processor is set up to correct the timing of a wave identified within the time interval if it is possible to ascertain a discrepancy from the time sequence of preceding or succeeding waves.

87. Control apparatus for an adjusting device in a motor vehicle, having
a processor which is set up to execute a method according to one of claims 1 to 43, and
a power driver, connected to the processor, for controlling a drive current for a drive in the adjusting device.

88. Digital storage medium, particularly data storage medium, with electronically readable control signals which can cooperate with a programmable processor such that a method according to one of claims 1 to 43 is executed.

89. Computer program product with a program code stored on a machine-readable storage medium for the purpose of carrying out the method according to one of claims 1 to 43 when the program product is running on a processor.

90. Computer program with a program code for carrying out the method according to one of claims 1 to 43 when the program product is running on a processor.
